(19) United States
(12) Patent Application Publication
(10) Pub. No.: US 2022/0166507 A1
(43) Pub. Date: May 26, 2022

(54) Data Transmission from Smart Device to Headless IoT (Internet of Things) Device

(71) Applicant: Jonathan Loren Newman, Schaumburg, IL (US)

(72) Inventor: Jonathan Loren Newman, Schaumburg, IL (US)

(21) Appl. No.: 17/520,469

(22) Filed: Nov. 5, 2021

Related U.S. Application Data
(60) Provisional application No. 63/116,456, filed on Nov. 20, 2020.

(51) Int. Cl. H04B 10/116; H04W 48/10; H04W 12/06

(52) U.S. Cl. CPC H04B 10/116; H04W 4/80; H04W 12/06; H04W 48/10

(57) ABSTRACT

A system and method to pass data from a SmartDevice (cellphone, smartphone, notebook computer, personal computer, tablet or similar) to a headless IoT device that lacks a display and/or keyboard. This system uses the SmartDevice's integral visible light sources (illuminated screen/display, camera LED light and/or separate LED light) to send data as encoded/pulsed/modulated visible light. The headless IoT device then receives the encoded/pulsed/modulated visible light with a Light Sensor. The IoT device's Light Sensor then decodes the incoming encoded/pulsed/modulated visible light into an electrical output. A Central Processing Unit can then further extract the original sent data from the Light Sensor's electrical output. A representative use case is for a SmartDevice to pass a WiFi Access Point's credentials (Access point name and password) to a headless IoT device, allowing the IoT device (with no display or keyboard) to connect to the WiFi Access Point.

### CROSS-REFERENCE TO RELATED APPLICATIONS

This application claims the benefit of and priority to U.S. Provisional Application No. U.S. 63/116,456, filed Nov. 20, 2020, which is hereby fully incorporated herein by reference.

### FIELD OF THE INVENTION

The present invention relates to the field of wireless connectivity for IoT (Internet of Things) devices. Specifically, the present invention relates to a novel method using visible light waves to pass data/information from a SmartDevice (defined here as, but not limited to. Smartphone, PC (Personal Computer), Tablet PC, or similar) to a headless IoT device that lacks a display and/or keyboard.

This invention is useful to pass user data/information from a SmartDevice (that has a keyboard and screen/display) to an IoT device (that does not have a keyboard and/or screen/display). An example of this is to pass the WiFI (Wireless Fidelity) commissioning credentials (like the WiFi Name and Password) for a WiFi Access Point (AP) to an IoT device, so the IoT device may successfully connect to the WiFi Access point and ultimately the World Wide Web

### BACKGROUND OF THE INVENTION

IoT (Internet of Things) devices have become a common part of everyday life. Many of these IoT devices connect directly to the home or business WiFi Access Point (AP). Since many/most IoT devices do not contain a screen/display or keyboard, it is a challenge to input/enter the WiFi AP Name and Password into the IoT device, so the IoT device may connect to the WiFi AP. Some existing methods to solve this challenge include.

1. Using a BLE (BlueTooth Low Energy) Radio to send WiFi credentials over BLE from a SmartDevice (with a BLE radio) to an IoT Device. This adds complexity to the SmartDevice & IoT device Application software and also adds the cost (of adding BLE) to the IoT device.

2. Temporarily making the WiFi IoT device into a WiFI AP itself, connecting a smartphone (with WiFi) to the IoT device, and passing the WiFi credentials to the IoT device (with the IoT device temporarily acting as an AP). This adds complexity to the IoT device and makes for a much more complex user experience. In some cases, the SmartDevice cannot support this method so there must also be a backup/alternative commissioning method included.

3. Attempting to snoop the WiFi credentials as a SmartDevice itself connects/communicates with the WiFi AP. This method is not reliable and prone to failure, so there must also be a backup/alternative commissioning method included. Therefore, what is needed are techniques/methods that overcome the above-mentioned disadvantages.

### BRIEF SUMMARY OF THE INVENTION

This invention allows a SmartDevice to send data/information (for example WiFi commissioning credentials like a WiFI AP name and password) to an IoT device using blinking visible light emitted from the SmartDevice's integral screen/display and/or it's camera light/LED (Light Emitting Diode).

To accomplish this, this invention makes use of the SmartDevice's integral.
1. SmartDevice Keyboard: Used to allow the user to enter data/information (like a WiFi AP's name and password).
2. The SmartDevice CPU (Central Processing Unit): Used to encode data/information (like a WiFi AP name and password) into a unique blinking visible light pattern that the IOT device can receive and decode.
3. The SmartDevice screen/display and/or LED (that emit visible light): Used to send encoded data/information to the IoT device using blinking visible light emitted from the SmartDevice's screen/display and/or LED. An LED that emits InfraRed light could also be used if the IoT device can receive Infrared light.

The IoT device, with an included Ambient Light Sensor (or ALS), is then able to receive the blinking encoded visible light emitted from the SmartDevice with encoded information (like the WiFi AP's name and password). The IoT device is then able to decode/extract the data/information (like the WiFi AP name and password) from the encoded blinking visible light. An Infrared light sensor could also be used on the IoT device if the SmartDevice can emit Infrared light.

The IoT device microcontroller can then use this decoded information (like WiFi AP name and password) to do something useful (like connect the IoT device to a WiFi AP).

### BRIEF DESCRIPTION OF THE DRAWINGS

The present invention is illustrated by way of example and not limitation in the figures of the accompanying drawings in which like references indicate similar elements.

FIG. 1 Depicts and illustrates one example of the present invention implemented as an apparatus and method to pass WiFi Access Point (AP) credentials (like AP name and password) using visible (and/or infrared) light from a SmartDevice to an IoT (Internet of Things) device which does not have a display or keyboard, as an example embodiment of the present invention.

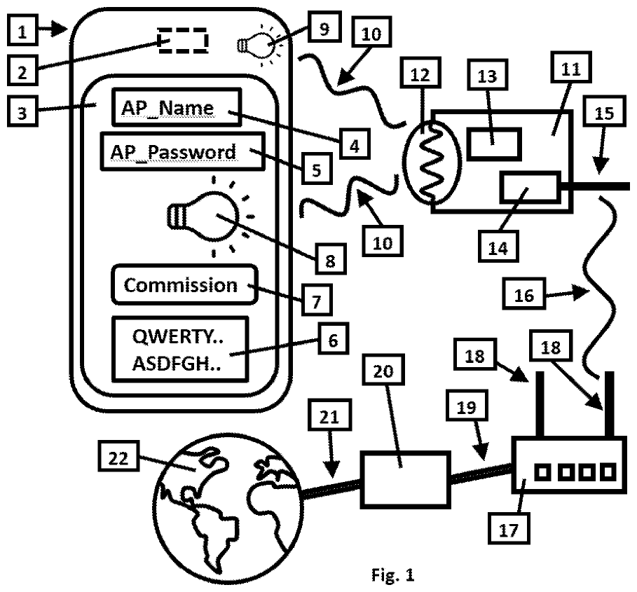

Description of items in FIG. 1.
1. SmartDevice like Smartphone, Personal Computer, Tablet or other device with a display and (real or Virtual) keyboard.
2. Microprocessor, Microcontroller or processor (inside the SmartDevice) running an Application Program on the SmartDevice.
3. Application Program running on the SmartDevice.
4. Application Program “data entry form”, used for entering data/information for example an Access Point (AP) Name
5. Application Program “data entry form”, used for entering data/information for example an Access Point (AP) Password
6. Application Program Virtual Keyboard for user to enter information into Application Program Forms
7. Application Program Virtual Button used for the user to initiate a command, for example to initiate the commissioning of an IoT device with WiFi connection credentials.
8. SmartDevice screen/display that can emit Blinking Visible Light
9. SmartDevice illumination Light/LED (Light Emitting Diode) that can emit Blinking Visible Light
10. Visible Light Waves emitting from the SmartDevice screen/display and/or the SmartDevice illumination Light/LED(Light Emitting Diode)
11. WiFi IoT Device without display and/or keyboard
12. WiFi IoT Device Ambient Light Sensor (ALS) capable of receiving and discerning visible light and blinking visible light
13. Microprocessor, Microcontroller or processor (inside the IoT device) running the IoT device
14. WiFi IoT radio capable of communicating with WiFi Access Point (AP)
15. WiFi IoT antenna for WiFi signal transmission/reception
16. WiFi radio signals propagating to/from IoT device to/from WiFi Access Point (AP)
17. WiFi Access Point (AP) capable of communicating with other WiFi devices like
WiFi Connected IoT devices.
18. WiFi AP antenna for WiFi signal transmission/reception
19. Wired connection (like ethernet) to an Internet/WorldWideWeb(WWW) portal, like a cable modem.
20. Device used for connection to the internet/WWW (like a cable modem)
21. Wired or wireless connection to an internet service provider for connection to the internet/WWW
22. The Internet/WWW

### DETAILED DESCRIPTION OF THE INVENTION

An embodiment and aspects of the present invention will be described with reference to details discussed below, and the accompanying drawing will illustrate an embodiment. The following description and drawing are illustrative of the invention and are not to be construed as limiting the invention. Numerous specific details are described to provide a thorough understanding of the example embodiment of the present invention. However, in certain instances, well-known or conventional details are not described in order to provide a concise discussion of embodiments of the present invention.

FIG. 1. Depicts and illustrates one example of the present invention implemented as the apparatus and method to pass useful information like WiFi Access Point (AP) connection credentials (like AP name and password) from a SmartDevice to an IoT (Internet of Things) device which does not have a display or keyboard, as an example embodiment of the present invention.

In this example application to allow an IoT device (11) to connect to a WiFi AP (17), a SmartDevice (1) is running a SmartDevice application program (3) with SmartDevice Microprocessor (2).

The application (3) allows the user to enter data/information into the SmartDevice application (3) like for example a WiFi AP (17) Name into application form (4) using virtual keyboard (6).

The application (3) allows the user to enter data/information into the SmartDevice application (3) like for example a WiFi AP (17) Password into application form (5) using virtual keyboard (6)

With the WiFI AP (17) Name and Password entered and available to the application (3), the user then presses the virtual commission button (7) to begin processing the data/information like for this example, a WiFi commissioning process of an IoT Device (11).

The application (3) then encodes the WiFi AP (17) Name and Password that were entered into application (3) forms (4 and 5) with microprocessor (2) into a blinking pattern suitable for conveyance with blinking visible light. This encoding scheme (hereafter called “encoding”) could be, but is not limited to a “morse-code” style encoding that would use short timed pulses of light to convey a unique pattern of timed (off/on) pulses for each unique character entered into forms (4 and 5) with the virtual keyboard (6).

Each character entered with virtual keyboard (6), for example a WiFi AP (17) Name and Password, will have a unique encoding that is understood by both the Application (3) for encoding purposes and by the IoT device (11) microcontroller (13) for decoding purposes.

The application (3) with microprocessor (2) encodes the WiFi AP (17) Name and Password into a string of blinking light patterns that the IoT device (11) will be able to receive, decode, understand and make use of.

The Application (3) then visibly blinks the SmartDevice (1) screen/display (8) and/or LED (9) with the encoded blinking off/on pattern, containing, for this example, the encoded WiFi AP (17) Name and Password.

The blinking screen/display (8) and/or LED (9) then emit visible blinking encoded light waves (10) in the encoded blinking off/on pattern which then propagates through the air/gap to the IoT device (11) Ambient Light Sensor (12).

The IoT device (11) Ambient Light Sensor (12) receives the visible blinking light (10) containing the encoded WiFi AP (17) Name and Password and passes the information to the IoT device (11) microcontroller (13).

The IoT device (11) microcontroller (13) then decodes the received and encoded WiFi AP Name & Password and extracts the actual AP Name and Password from the blinking visible light pattern (10) received by the IoT (11) ambient light sensor (12).

IoT WiFi Device (11) then sends the decoded WiFi AP (17) Name and Password to the WiFi AP (17) over WiFi Radio waves (16) with WiFi Radio (14) and WiFi Antenna (15). With the WiFi Antenna (18) WiFi AP (17) receives the WiFi AP (17) Name and Password sent from the WiFi IoT device (11) and then allows the WiFi IoT device (11) to successfully “connect” to the WiFi AP (17).

WiFi IoT Device (11) is then allowed by WiFi AP (17) to connect to the World Wide Web (22) thru the WWW access hardware (20) like a cable modem, using wired (Or wireless) interface (19) and then using the wired (or wireless) interface (21) connection to the World Wide Web (22).

WiFi Device (11) with no keyboard or display, using the WiFi IoT (17) Name and Password received via visible light pulses from the SmartDevice (1) is thus able to connect to the WiFi AP (17) and to the World Wide Web (22).

What is claimed is:

1. An apparatus, comprising Electronic Circuitry further comprising a Central Processing Unit; a Wireless Radio Unit; and a Light Sensing Unit.

2. The apparatus of claim 1, wherein the Wireless Radio Unit comprises wireless radio circuitry capable of wireless communications with one or any number of various Wireless Protocols including but not limited to WiFi, BLE (Bluetooth Low Energy), Bluetooth, Zigbee, Sub1GHz Zigbee, Amazon Sidewalk, Thread, CHIP (Connected Home Interface Protocol), Matter and Apple HomeKit.

3. The apparatus of claim 1, wherein the Light Sensing Unit is capable of receiving pulsing/modulated visible and/or invisible light and is able to output an electrical signal indicative of the intensity of the received pulsing/modulated received visible and/or invisible light.

4. The apparatus of claim 1, wherein the Central Processing Unit comprises an MCU/MPU (Microcontroller/Microprocessor) capable of controlling/running the Wireless Radio Unit; capable of controlling/running the Light Sensing Unit; capable of running timers and algorithms to decode and interpret the incoming data from the Light Sensing Unit output electrical signal.

5. An apparatus, comprising Electronic Circuitry further comprising a System On Chip (SOC) further comprising a Central Processing Unit and a Wireless Radio Unit; and a Light Sensing Unit.

6. The apparatus of claim 5, wherein the Light Sensing Unit is capable of receiving pulsing/modulated visible and/or invisible light and is able to output an electrical signal indicative of the intensity of the received pulsing/modulated visible and/or invisible light.

7. The apparatus of claim 5, wherein the Wireless Radio Unit comprises wireless radio circuitry capable of wireless communications with one or any number of various Wireless Protocols including but not limited to WiFi, BLE (Bluetooth Low Energy), Bluetooth, Zigbee, Sub1GHz Zigbee, Amazon Sidewalk, Thread, CHIP (Connected Home Interface Protocol), Matter and Apple HomeKit.

8. The apparatus of claim 5, wherein the Central Processing Unit comprises an MCU/MPU (Microcontroller/Microprocessor) capable of controlling/running the Light Sensing Unit; capable of controlling/running the Wireless Radio; capable of running timers and algorithms to decode and interpret the incoming data from the apparatus of Light Sensing Unit output electrical signal.

9. A method of using modulated/pulsed/encoded visible and/or invisible light emitted from a SmartDevice's (for example but not limited to smartphone, cellphone, personal computer, notebook computer or tablet personal computer) integral illuminated display screen and/or LED Camera Light and/or other LED light to output/send/transmit useful data, with the useful data included and encoded in the modulated/pulsed emitted light.

10. A method of passing data with visible and/or invisible light emitted from a SmartDevice, for example (but not limited to) a smartphone, cellphone, personal computer, notebook computer or tablet personal computer to the apparatus of claim 1, comprising the following steps:
the SmartDevice converts some data for example (but not limited to) a WiFi Access Point's Name & Password into a unique timed/pulsed pattern of pulsed/modulated light;
the SmartDevice's illuminated display screen or LED Camera Light or other LED light is then modulated/pulsed according to the unique timed/pulsed pattern;
the SmartDevice's illuminated display screen or LED Camera Light or other LED light then emits light in the same unique timed/pulsed pattern;
the apparatus of claim 1 Light Sensing Unit then receives the pulsed/modulated light emitted from the SmartDevice;
the apparatus of claim 1 Light Sensing Unit then outputs an electrical signal indicative of the timing of the received pulsed/modulated light to the apparatus of claim 1 Central Processing Unit;
the apparatus of claim 1 Central Processing Unit receives the pulsed/modulated electrical output signal from the apparatus of claim 1 Light Sensing Unit;
the apparatus of claim 1 Central Processing Unit then decodes the pulsed/modulated electrical output signal from the apparatus of claim 1 Light Sensing Unit, back into the original data that was sent;
the data sent from the SmartDevice is thus received by the apparatus of claim 1 Central Processing Unit;
the apparatus of claim 1 Central Processing Unit can then interpret and use this received data, for example but not limited to a WiFi Access point Name and password and take action based on the received data, for example (but not limited to) connecting the apparatus of claim 1 Wireless Radio Unit to a WiFi Access point with the received WiFi Access Point Name and Password.

11. A method of passing data with visible and/or invisible light emitted from a SmartDevice, for example (but not limited to) a smartphone, cellphone, personal computer, notebook computer or tablet personal computer to the apparatus of claim 5, comprising the following steps:
the SmartDevice converts some data for example (but not limited to) a WiFi Access Point's Name & Password into a unique timed/pulsed pattern of pulsed/modulated light;
the SmartDevice's illuminated display screen or LED Camera Light or other LED light is then modulated/pulsed according to the unique timed/pulsed pattern;
the SmartDevice's illuminated display screen or LED Camera Light or other LED light then emits light in the same unique timed/pulsed pattern;
the apparatus of claim 5 Light Sensing Unit then receives the pulsed/modulated light emitted from the SmartDevice;
the apparatus of claim 5 Light Sensing Unit then outputs an electrical signal indicative of the timing of the received pulsed/modulated light to the apparatus of claim 5 Central Processing Unit;
the apparatus of claim 5 Central Processing Unit receives the pulsed/modulated electrical output signal from the apparatus of claim 5 Light Sensing Unit;
the apparatus of claim 5 Central Processing Unit then decodes the pulsed/modulated electrical output signal from the apparatus of claim 5 Light Sensing Unit, back into the original data that was sent;
the data sent from the SmartDevice is thus received by the apparatus of claim 5 Central Processing Unit;
the apparatus of claim 5 Central Processing Unit can then interpret and use this received data, for example but not limited to a WiFi Access point Name and password and take action based on the received data, for example (but not limited to) connecting the apparatus of claim 5 Wireless Radio Unit to a WiFi Access point with the received WiFi Access Point Name and Password.
